(19) United States
(12) Patent Application Publication
(10) Pub. No.: US 2015/0181291 A1
(43) Pub. Date: Jun. 25, 2015

(54) METHODS AND SYSTEMS FOR PROVIDING ANCILLARY CONTENT IN MEDIA ASSETS

(71) Applicant: United Video Properties, Inc., Santa Clara, CA (US)

(72) Inventor: David John Wheatley, Tower Lakes, IL (US)

(73) Assignee: United Video Properties, Inc., Santa Clara, CA (US)

(21) Appl. No.: 14/137,796

(22) Filed: Dec. 20, 2013

(51) Int. Cl. H04N 21/454; H04N 21/44; H04N 21/45; H04N 21/81; H04N 21/442

(52) U.S. Cl. CPC H04N 21/4542; H04N 21/812; H04N 21/44218; H04N 21/4532; H04N 21/44016

(57) ABSTRACT

Methods and systems are disclosed herein for providing ancillary content in media assets. Specifically, a media guidance application may alert a user to remove, or modify, portions of a media asset based on an emotional response profile associated with the media asset. The emotional response profile may indicate representative emotional responses of other users associated with one or more progression points of the media asset. Upon determining that a user currently consuming the media asset is approaching a portion of the media asset associated with undesirable emotional responses, the media guidance application may alert the user to remove, or modify, the undesirable portion.

### BACKGROUND

Users have a plethora of media content options to select from in typical media systems. Furthermore, while users may enjoy the majority of selected media content, users may also wish to avoid and/or modify some portions of the media content. For example, while a typical user generally enjoys horror movies, the user may not wish to see particular gory scenes. While some parental control systems may block media content with a particular rating, those parental control systems are not effective in blocking particular scenes. Moreover, even if particular scenes of media content can be removed, problems arise in identifying which portions should or should not be removed according to the individual tastes of the user.

### SUMMARY

Accordingly, methods and systems are disclosed herein for providing ancillary content in media assets. Specifically, a media guidance application may alert a user to, remove, or modify portions of a media asset based on an emotional response profile associated with the media asset. The emotional response profile may indicate representative emotional responses of other users associated with one or more progression points of the media asset. Upon determining that a user currently consuming the media asset is approaching a portion of the media asset associated with undesirable emotional responses, the media guidance application may alert the user to remove, or modify, the undesirable portion.

In some aspects, the media guidance application generates a display of a media asset to a user identifying a first progression point of the media asset and retrieving an emotional response profile associated with the media asset, in which the emotional response profile indicates representative emotional responses of other users associated with each progression point of the media asset. The media guidance application may then determine a first representative emotional response associated with the first progression point based on the emotional response profile and compare the first representative emotional response to a threshold emotional response. The media guidance application may then generate a display of secondary content at a second progression point of the media asset in response to determining that the first representative emotional response corresponds to the threshold emotional response.

In some embodiments, the secondary content may be associated with a representative emotional response that does not corresponds to the threshold emotional response. For example, in response to determining that a portion of a media asset (e.g., associated with a particular progression point of the media asset) is undesirable, the media guidance application may provide secondary content in order to reduce undesirable emotional responses.

In some embodiments, for example, in which the second progression point is before the first progression point, the secondary content is an alert indicating to the user that the representative emotional response associated with the upcoming progression point corresponds to the threshold emotional response. For example, the media guidance application may warn the user that a scene of the media asset is scary or may provide an advertisement associated with an enjoyable scene (e.g., providing options to buy products shown in the scene) of the media asset. Additionally or alternatively, the media guidance application may use the secondary content to replace content associated with the first progression point. For example, the media guidance application may replace undesirable scenes or portions (e.g., featuring violence, unhappy endings, etc.) in an otherwise desirable media assets with desirable scenes or portions (e.g., limited violence, happy endings, etc.).

In some embodiments, the representative emotional response associated with each progression point in the media asset is determined based on monitoring emotional responses of the other users while the other users are consuming the media assets and quantifying the emotional response of each of the other users at a progression point in the media asset. The media guidance application may then average the quantified emotional responses of each of the other users for the progression point in the media asset to determine the representative emotional response associated with the progression point in the media asset. For example, the media guidance application may monitor, or receive data indicating, the emotional responses of the other users while the other users are consuming the media assets. The media guidance application may then assign a number or other designation that indicates an emotion and/or the level of a particular emotion to the progression points of a media asset at which the each of the other users experienced the emotional response. The media guidance application may then average the quantified emotional responses of each of the other users for each of the progression points in the media asset to determine the representative emotional response associated with each progression point in the media asset. For example, if a majority of users experience “sadness” at the thirty-minute mark of a media asset, the media guidance application may associated the thirty-minute mark with an emotional response of “sadness.”

In some embodiments, the threshold emotional response is based on the media guidance application quantifying the representative emotional responses associated with each progression point of the media asset and averaging the quantified representative emotional responses associated with each progression point of the media asset. The media guidance application may then select a deviation from the quantified representative emotional responses that corresponds to the threshold emotional response. For example, the media guidance application may determine that a media asset has an average emotional response experience by other users associated with a particular emotion (e.g., “fear”) throughout the media asset. The media guidance application may also determine that at the twenty-minute mark and the fifty-minute mark of the media asset the emotional response measurement associated with “fear” deviates from the average (e.g., indicating an increase in the number of other users that experience “fear” at that progression point). The media guidance application may then determine whether the deviation corresponds to a deviation associated with a threshold emotional response.

In some embodiments, the media guidance application may determine the deviation corresponds to a deviation associated with a threshold emotional response based on the magnitude of the deviation, the number and/or percentage of other users that exhibited the deviation, and/or a user profile associated with the user. For example, if the user profile indicates that the user typically does not view media assets with deviations of a “high” magnitude, the media guidance application may determine that the threshold emotional response for the user corresponds to deviations of a “high” magnitude.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 is an illustrative display of a media guidance application in accordance with some embodiments of the disclosure;

FIG. 2 is another illustrative display of a media guidance application in accordance with some embodiments of the disclosure;

FIG. 3 is a block diagram of an illustrative system used in accordance with some embodiments of the disclosure;

FIG. 4 is an illustrative diagram of a media system in accordance with some embodiments of the disclosure;

FIG. 5A is an illustrative diagram of an emotional response profile tracking multiple emotions for a media asset in accordance with some embodiments of the disclosure;

FIG. 5B is an illustrative diagram of an emotional response profile for a media asset being compared to an emotional response profile for a user in accordance with some embodiments of the disclosure;

FIG. 6 is a flow-chart of illustrative steps involved in generating a display of secondary content for a media asset in accordance with some embodiments of the disclosure; and

FIG. 7 is a flow-chart of illustrative steps involved in generating an emotional response profile in accordance with some embodiments of the disclosure.

### DETAILED DESCRIPTION OF THE DRAWINGS

Methods and systems are disclosed herein for a media guidance application capable of providing ancillary content in media assets. As referred to herein, “a media guidance application,” “interactive media guidance application,” or “guidance application,” is an application that allows users, via an interface, to efficiently navigate, view, and/or review media assets and easily identify desirable and undesirable content. In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor caches, Random Access Memory (“RAM”), etc.

In some embodiments, a media guidance application may alert a user to add, remove, and/or modify portions of a media asset based upon identifying that the portions of the media asset may include desirable or undesirable content. To identity portions of the media asset deemed to be desirable or undesirable, the media guidance application may interpret an emotional response profile associated with the media asset. As used herein, “a desirable portion”_ of a media asset refers to a portion of a media asset that invokes a positive emotional response or a particular amount of a positive emotional response. For example, the media guidance application may determine that a portion of a media asset that typically makes a user happy, excited, joyful, etc. is a desirable portion. In another example, the media guidance application may determine that a portion of a media asset that typically makes a user only a certain degree of happy is a desirable portion. In contrast, as used herein, “an undesirable portion”_ of a media asset refers to a portion of a media asset that invokes a negative emotional response or a particular amount of a negative emotional response. For example, the media guidance application may determine that a portion of a media asset that typically makes a user scared, unhappy, sad, etc. is an undesirable portion. In another example, the media guidance application may determine that a portion of a media asset that typically makes a user only a certain degree of scared is an undesirable portion.

It should be noted that in some embodiments, the media guidance application may automatically determine (e.g., based on instructions previously received and/or from a third party) what constitutes positive and negative emotional responses and/or the degree of positive or negative emotional responses for use in determining the desirability or undesirability of a portion of a media asset. Additionally or alternatively, the media guidance application may request a user enter determinations for what constitutes positive and negative emotional responses and/or the degree of positive or negative emotional responses for use in determining the desirability or undesirability of a portion of a media asset (e.g., as discussed below).

As used herein, “an emotional response profile,” refers to data representative of one or more emotions experienced by a consumer of a media asset. As used herein “an emotion” may include any subjective, conscious experience characterized primarily by psychophysiological expressions, biological reactions, and mental states.

In some embodiments, emotional response profiles may include emotional responses to the consumption of a media asset by one or more users. The emotional responses for multiple users may be segregated or aggregated based on a progression point in the media asset, information (e.g., information indicating demographic, familial, social network, and/or any other suitable relationships or groupings) associated with a user providing the emotional response, the emotion, or level of emotion experienced, and/or any other information necessary to generate, search, interpret, and/or maintain the emotional response profile.

For example, data related to progression points may indicate particular portions of a media asset at which one or more users experienced a particular emotion and/or level of the particular motion. As used herein, “a progression point” refers to a finite instance in the run-time of a media asset. In some embodiments, a progression point may be identified by the time-mark (e.g., thirty-second mark, ten-minute mark, etc.) of the run-time of the media asset. The progression point may also correspond to beginning, end, or other length of time corresponding to a particular scene (e.g., in a sequence of scenes) or portion of a media asset. For example, in some embodiments, a progression point may correspond to a portion of a media asset occurring from a first time-mark (e.g., the fifteen-minute mark) to a second time-mark (e.g., the seventeen-minute mark). Additionally, a progression point may correspond to a representative emotional response.

In some embodiments, the representative emotional responses associated with each progression point in the media asset is determined based on monitoring emotional responses of the other users while the other users are consuming the media assets and quantifying the emotional response of each of the other users at a progression point in the media asset. The media guidance application may then average the quantified emotional responses of each of the other users for the progression point in the media asset to determine the representative emotional response associated with the progression point in the media asset. For example, the media guidance application may monitor, or receive data indicating, the emotional responses of the other users while the other users are consuming the media assets. The monitoring of particular psychological or physiological conditions (e.g., stress level, mood, emotion, etc.) is described in depth in Klappert et al., “Methods and Systems for Sharing Psychological or Physiological Conditions of a User,” Atty. Docket No. 003597-0956-101, U.S. patent application Ser. No. 14/137,552, filed Dec. 20, 2013, which is hereby incorporated by reference herein in its entirety.

The media guidance application may then assign a number or other designation that indicates an emotion and/or the level of a particular emotion to the progression points of a media asset at which each of the other users experienced the emotional response. It should be noted, the number and/or other quantification of an emotion and/or level of a particular emotion may be based on any suitable method that properly distinguishes between the various emotions and/or levels of emotions.

The media guidance application may then average the quantified emotional responses of each of the other users for each of the progression points in the media asset to determine the representative emotional response associated with each progression point in the media asset. For example, if a majority of users experience “anxiety” at the thirty-minute mark of a media asset, the media guidance application may associate the thirty-minute mark with an emotional response of “anxiety.”

In some embodiments, the threshold emotional response is based on the media guidance application quantifying the representative emotional responses associated with each progression point of the media asset, averaging the quantified representative emotional responses associated with each progression point of the media asset. The media guidance application may then select a deviation from the quantified representative emotional responses that corresponds to the threshold emotional response. For example, the media guidance application may determine that a media asset has an average emotional response experience by other users associated with a particular emotion (e.g., “disgust”) throughout the media asset. The media guidance application may also determine that at the twenty-minute mark and the fifty-minute mark of the media asset the emotional response measurement associated with “disgust” deviates from the average (e.g., indicating an increase in the number of other users that experience “disgust” at that progression point). The media guidance application may then determine whether the deviation corresponds to a deviation associated with a threshold emotional response.

In some embodiments, the media guidance application may determine the deviation corresponds to a deviation associated with a threshold emotional response based on the magnitude of the deviation, the number and/or percentage of other users that exhibited the deviation, and/or a user profile associated with the user. For example, if the user profile indicates that the user typically does not view media assets with deviations of a “high” magnitude, the media guidance application may determine that the threshold emotional response for the user corresponds to deviations of a “high” magnitude.

In some embodiments, the media guidance application may search and/or filter the emotional responses used to generate the emotional response profile based on one or more criteria. For example, the media guidance application may filter the emotional responses such that only emotional responses associated with users in a similar demographic, familial, social network, and/or any other suitable relationship or grouping are used. For example, the media guidance application may retrieve information about the user from a user profile indicating one or more groups associated with the user, filter an emotional response profile associated with the media asset for only emotional responses received from only other users in the one or more groups.

In some embodiments, the media guidance application may retrieve other information associated with the user from a user profile associated with the user. For example, the media guidance application may retrieve user preferences, user viewing histories, deviations, and magnitudes thereof, for average emotional responses during one or more media assets, and/or any other information for use in identifying desirable and/or undesirable portions of a media asset and/or recommending secondary content. For example, a user profile may indicate typical media assets (and/or the emotional profiles associated with those media assets) viewed by a user. In some cases, the user profile may include emotional response data generated by monitoring the user (e.g., in real-time) while the user consumes a media asset.

In some embodiments, upon determining that a user currently consuming the media asset is approaching a portion of the media asset associated with undesirable emotional responses, the media guidance application may alert the user to remove, or modify, the portion. For example, the media guidance application may generate a display of secondary content. As used herein, “secondary content” refers to any content that is presented to a user in response to the media guidance application identifying a portion of a media asset is desirable or undesirable portion.

In some embodiments, the secondary content may be generated in response to determining that a portion of a media asset corresponds to a threshold emotional response. As used herein, “a threshold emotional response,” refers to an emotional response that when identified by the media guidance application causes the media guidance application to perform an action other than normal playback of the media asset (e.g., generating a display of secondary content).

For example, in response to determining that a portion of a media asset (e.g., associated with a particular progression point of the media asset) is undesirable, the media guidance application may provide secondary content in order to reduce undesirable emotional responses. The secondary content may include an alert and/or other on-screen indication notifying the user of undesirable content (e.g., a warning indicating that an upcoming scene of a movie includes content meant to scare a user). The secondary content may additionally or alternatively provide an advertisement associated with an enjoyable scene. For example, in response to detecting that a particular scene of a media asset typically makes users excited, the media guidance application may include an advertisement for the product to be shown in the scene while the scene is shown (e.g., in order to advertise to an excited user).

Additionally or alternatively, the media guidance application may use the secondary content to replace undesirable content. For example, the media guidance application may replace undesirable scenes or portions with more desirable scenes. For example, in response to determining that a user is not enjoying content or that other users typically did not enjoy the current content of a media asset (e.g., based on an emotional response profile), the media guidance application may provide alternative content.

Upon identifying the emotional response associated with a first progression point of the media asset, the media guidance application may vary the progression point at which secondary content is presented. In some embodiments, the selection of the second progression point may depend on the type of secondary content. For example, if the secondary content is a warning, the second progression point may be selected by the media guidance application at a progression point prior to the first progression point (e.g., such that the appearance of the warning is before the content that the user needs to be warned about). The amount of time prior to the first progression point may be fixed (e.g., five seconds, one minute, etc.) or may vary based on the magnitude of the emotional response. For example, the media guidance application may provide the user with more warning time prior to portions of a media asset that invoke stronger emotional responses as compared to portions of the media asset that invoked weaker emotional responses. In another example, if the secondary content is content that should be consumed with (or in replacement of) the content of the first progression point (e.g., an advertisement), the second progression point may be selected by the media guidance application at a progression point substantially concurrent with a first progression point.

For example, the media guidance application may identify a first progression point of the media asset and determine a first representative emotional response associated with the first progression point based on an emotional response profile for the media asset. The media guidance application may then present the secondary content at a second progression point. For example, the media guidance application may present the secondary content and/or identify the undesirable content prior to the actual presentation of the undesirable content (e.g., in order to alert a user to upcoming undesirable content). Alternatively, the media guidance application may present the secondary content and/or identify the undesirable content substantially concurrently to the actual presentation of the undesirable content (e.g., in order to overlay the secondary content over the undesirable content and/or replace the undesirable content with the secondary content). The media guidance application may also present the secondary content and/or identify the undesirable content after the actual presentation of the desirable or undesirable content (e.g., in order to generate an advertisement for content recently consumed by a user).

Additionally or alternatively, the media guidance application may allow a user to determine the time interval (e.g., via user options) associated with different types of secondary content and/or different emotions and levels of emotion, or the media guidance application may receive instructions (e.g., embedded in the metadata of the media asset, from a provider of the media asset, etc.) indicating the appropriate time intervals.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

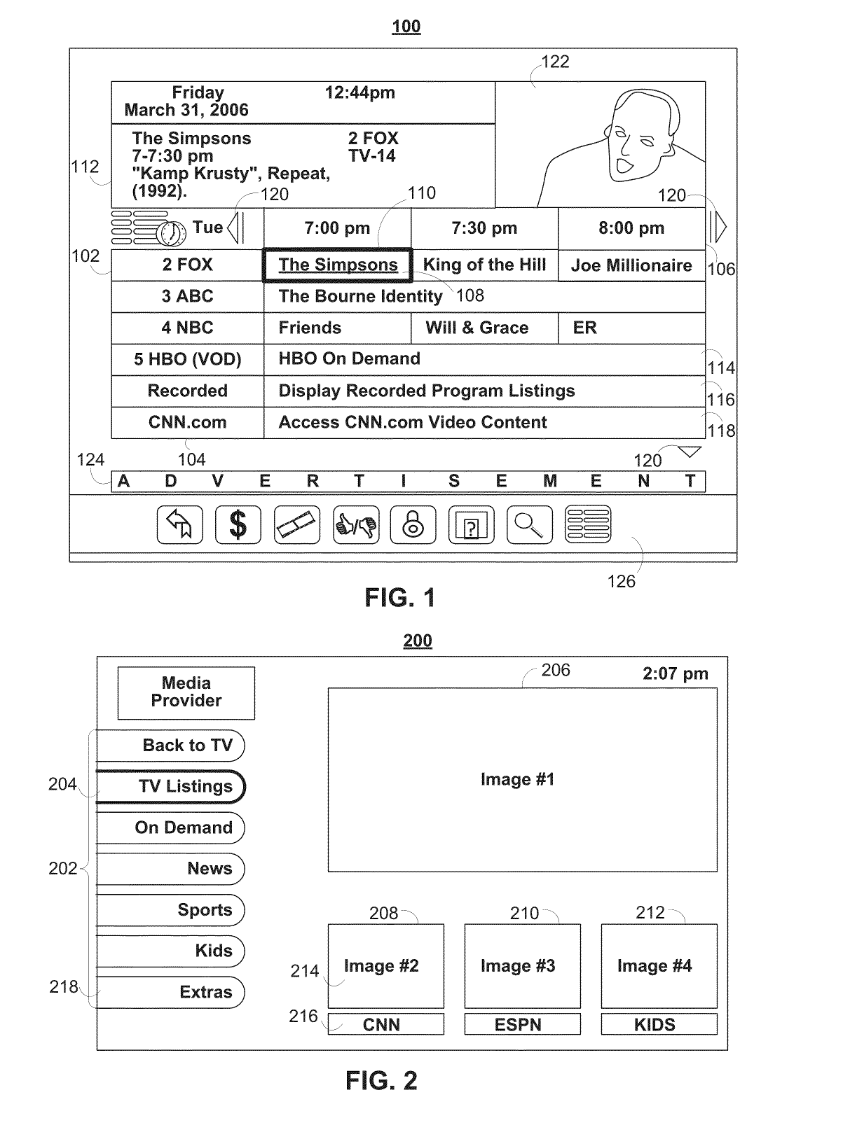

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Baumgartner et al., U.S. Patent Application Publication No. 2002/0174430, published Nov. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, published December Jun. 17, 2010, which is hereby incorporated by reference herein in its entirety.

Display 200 also includes selectable option 218. Selectable option 218 may be used to select options related to the presentation of secondary content. For example, the media guidance application may determine which portions of a media asset constitute desirable portions and undesirable portions based on the emotional responses that each portion invokes. In some embodiments, the media guidance application may receive instructions from a third party indicating, which emotional responses are associated with desirable portions and undesirable portion. Alternatively or additionally, the media guidance application may receive user selections via selectable option 218 that indicate which emotional responses are associated with desirable portions and undesirable portion. The media guidance application may then determine which portions of a media asset correspond to those emotional responses and label them desirable and/or undesirable.

Additionally or alternatively, the media guidance application may determine what constitutes positive and negative emotional responses and/or the degree of positive or negative emotional responses for use in determining the desirability or undesirability of a portion of a media asset. In some embodiments, the media guidance application automatically determine (e.g., based on instructions previously received and/or from a third party) what constitutes positive and negative emotional responses and/or the degree of positive or negative emotional responses for use in determining the desirability or undesirability of a portion of a media asset.

Additionally or alternatively, the media guidance application may base any of these determinations on active and/or passive user responses. For example, the media guidance application may receive active responses such as user input entering selections for particular determinations (e.g., such as what constitutes positive and negative emotional responses and/or the degree of positive or negative emotional responses for use in determining the desirability or undesirability of a portion of a media asset). In some embodiments, the media guidance application may receive the active response by entering a test mode and testing the emotional responses of a user while showing the user various portions of media assets. The media guidance application may then adjust the determinations with respect to the user based on a comparison of the emotional responses of the user and the emotional responses of others users when shown the same portion of a media asset.

In another example, the media guidance application may receive passive responses (e.g., via monitoring a user to determine user responses without directly query the user). In such cases, the media guidance application may calibrate its determinations by passively monitoring the emotional responses of a user while the user views various portions of the media assets. The media guidance application may then adjust the determinations with respect to the user based on a comparison of the emotional responses of the user and the emotional responses of others users that were shown the same portion of a media asset.

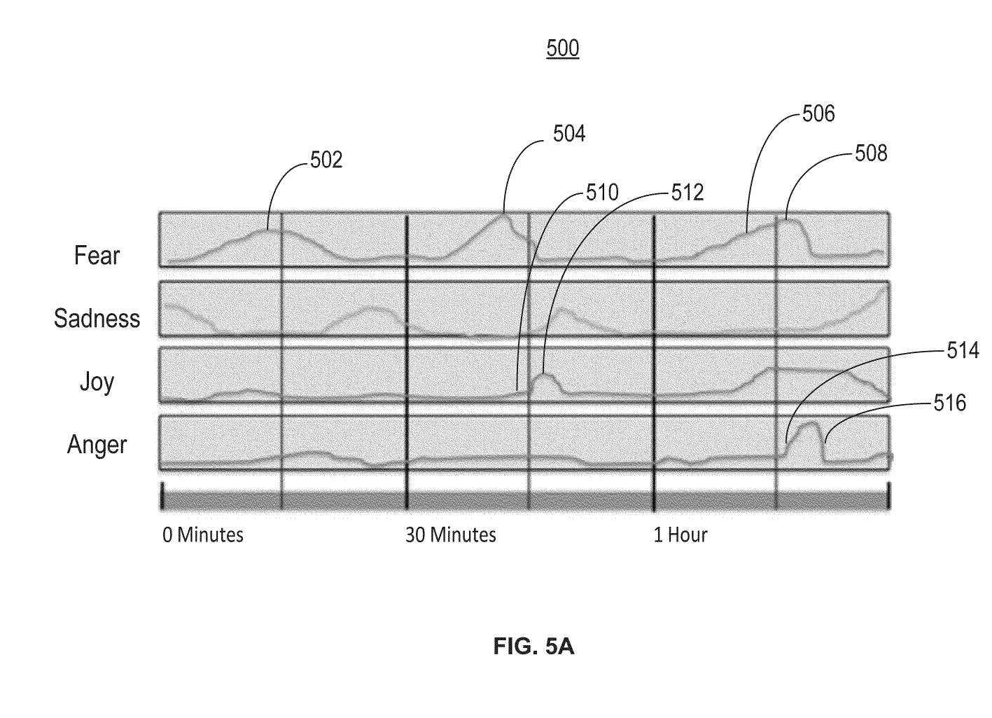

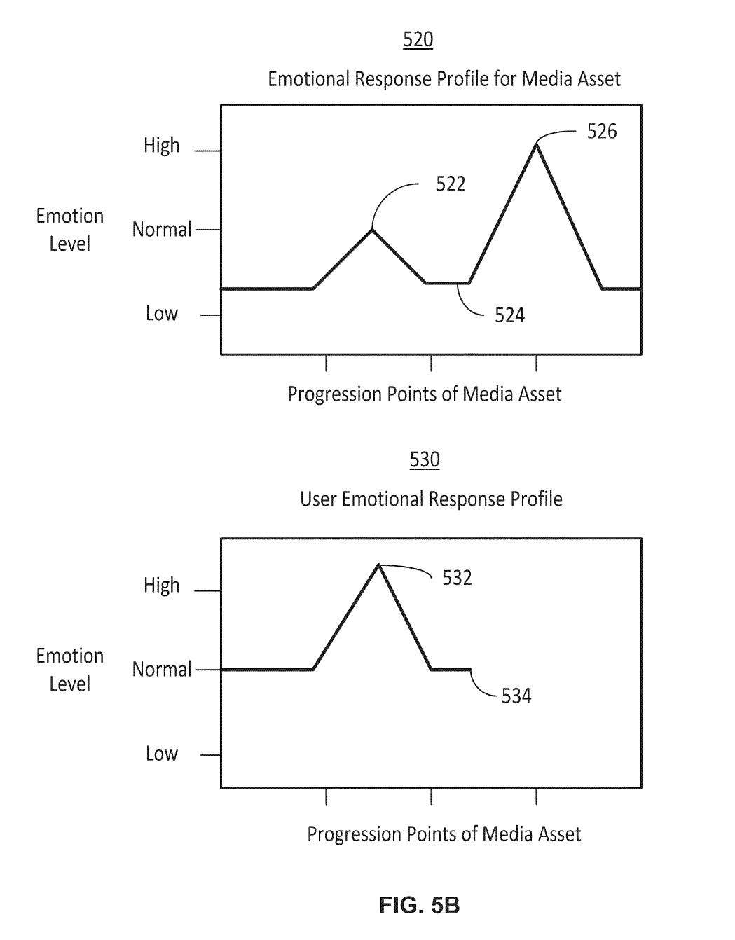

The media guidance application may continually update its determinations and/or calibrations based on monitored or received data. For example, any previous calibrations and/or determinations may be included in a user profile associated with the user (or a group of users). As more data is collected, the media guidance application may update the corresponding data in the user profile. For example, as discussed below in relation to FIG. 5B, the media guidance application may monitor the emotional responses of a user to determine the desirability or undesirability of particular portions of the media asset.

In some embodiments, the desirability or undesirability of a portion of a media asset may depend on the degree of emotional responses exhibited by a user. For example, if a user frequently has strong (e.g., higher than the average person) emotional responses (e.g., corresponding to a scared emotional state), the media guidance application may automatically determine that portions of a media asset that typically make other users scared are undesirable to the user (e.g., as such portions will likely make the user an extremely high level of scared). In contrast, if a user frequently has low (e.g., lower than the average person) emotional responses (e.g., corresponding to a scared emotional state), the media guidance application may automatically determine that portions of a media asset that typically make other users scared are desirable, or at least not undesirable, to the user (e.g., as such portions will not likely make the user scared).

The media guidance application may also includes settings (e.g., accessible via selectable option 218) for the particular emotional responses and/or the degrees of such emotional responses that trigger content, the particular type of content that is triggered, the length of time the content is shown prior to a particular desirable and/or undesirable portion of the media asset, and/or any other functions associated with the presentation of secondary content.

For example, the settings may allow a user to request that the media guidance application generates an alert ten seconds before a portion of a media asset associated with a particular level of an emotional responses (e.g., scared). In another example, the settings may allow a user request that the media guidance application generates an advertisement concurrently with, or a few seconds after, a portion of a media asset associated with any level of a group of positive emotional responses (e.g., happy, excited, etc.).

In some embodiments, the media guidance application may also allow a user to manually adjust the emotional response profile or to indicate particular progression points for presenting secondary content (as well as select the secondary content presented). Additionally or alternatively, the media guidance application may receive adjustments to the emotional response profile based on third party sources (e.g., critical reviews, social media posts, etc.), which may not be associated with the emotional responses of other users.

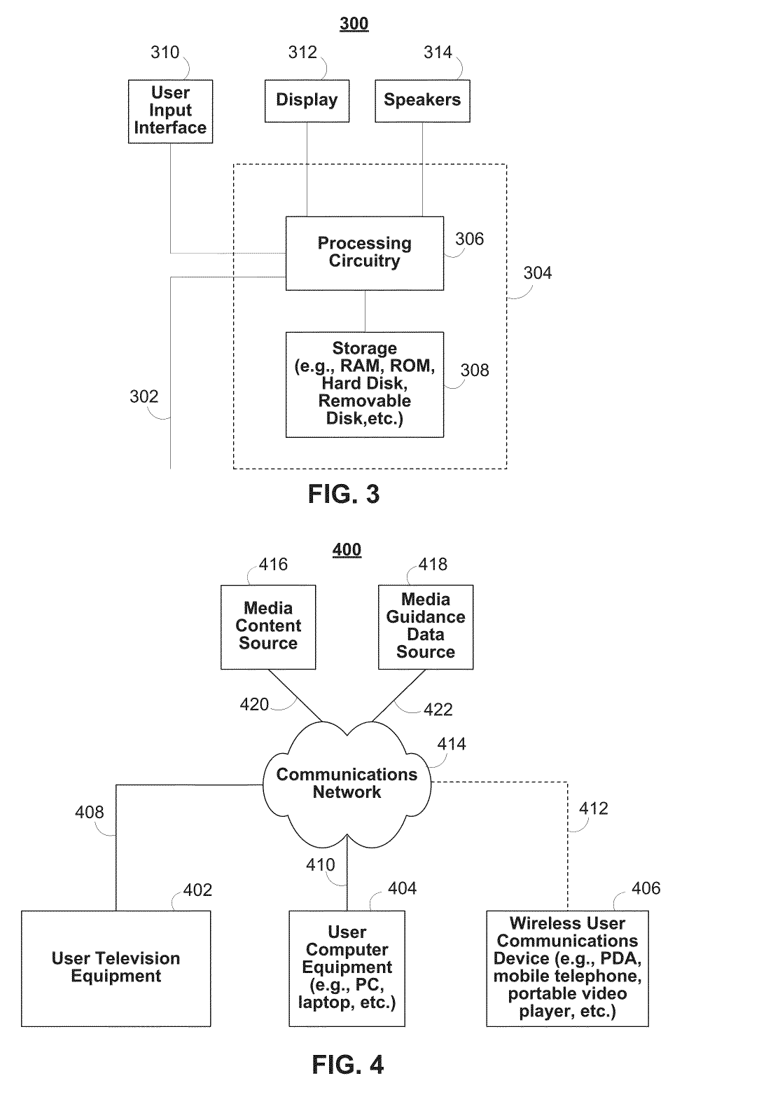

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5A is an illustrative diagram of an emotional response profile tracking multiple emotions for a media asset. FIG. 5A shows emotional response profile 500, which, in some embodiments, may represent an emotional response profile for a media asset. The emotional response profile is illustrated in a graphical form; however, emotional response profile 500 may also be translated into a listing of values for respective progression points (e.g., indicated as time-marks) for the media asset. It should be noted the emotional response profiles disclosed herein (e.g., emotional response profile 500) may be represented in several ways, including, but not limited to, graphical and tabular methods.

Emotional response profile 500 currently displays the emotional response profiles for four emotions, “fear,” “sadness,” “joy,” and “anger” as indicated by the y-axis of emotional response profile 500. It should be noted that emotional response profile 500 is illustrative only and different emotions and different amounts of emotions may be recorded in any given emotional response profile. Emotional response profile 500 currently displays the emotional response profile for two hours of a media asset (e.g., as indicated by the time-marks associated with the x-axis of emotional response profile 500).

As shown by emotional response profile 500, the emotional response profiles for the individual emotions vary in magnitude during the run-time of the media asset. The variations in the magnitudes may be used to determine whether or not a portion of a media asset is desirable or undesirable. For example, with respect to the emotional response profile for the emotion of “fear,” peaks in the magnitude of the emotional response profile may indicate undesirable (e.g., scary) portions of the media asset. For example, point 502, 504, and 508 each represent progression points at which the magnitude of the emotional response profile peaks.

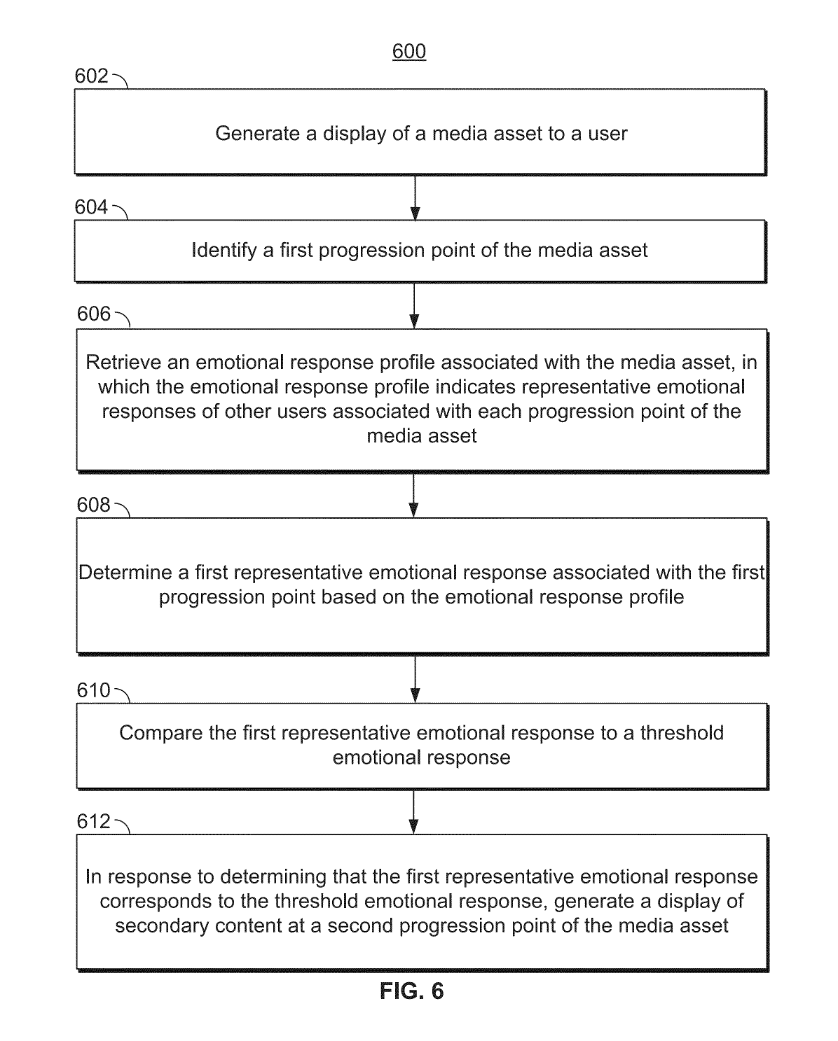

In some embodiments, the media guidance application may compare the emotional response associated with a first progression point to a threshold emotional response to determine whether or not to generate a display of secondary content (e.g., as discussed below in relation to FIG. 6) at a second progression point.

For example, in some embodiments, the media guidance application may generate secondary content at a second progression point (e.g., prior to a first progression point during normal playback of a media asset) in order to warn a user of an approaching undesirable portions of the media asset at a first progression point. For example, in emotional response profile 500, point 506 indicates a progression point prior to point 508 (e.g., associated with an undesirable portion of the media asset). At point 506, the media guidance application may generate a display of secondary content warning a user that an upcoming scene of the m68edia asset may be undesirable (e.g., scary).

In some embodiments, the media guidance application may receive the emotional response profile and/or location of the progression points in the emotional response profile prior to, or accompanying, a media asset. For example, in some embodiments, the media guidance application may receive the emotional response profile with a media asset (e.g., in data accompanying the media asset) or the media guidance application may retrieve an emotional response profile (e.g., from local storage such as storage 308 (FIG. 3) or remote storage such as any location accessible via communications network 414 (FIG. 4)). The media guidance application may then process the emotional response profile to determine what content, and when that content, should be presented during a presentation of a media asset.

For example, prior to generating a playback of a media asset the media guidance application may determine the location of each progression point at which secondary content may be generated. In another example, the media guidance application may determine the location of each progression point at which secondary content may be generated while the media asset is being played back. For example, the media guidance application may progressively scan (e.g., a few progression points ahead of a current progression point) for progression points that trigger secondary content. In some embodiments, the media guidance application may further compare the progression points that may trigger secondary content to user settings (e.g., as discussed in relation to FIG. 2) to determine whether or not the secondary content should be shown and/or when the secondary content should be shown.

Based on the emotional response profile, and/or the user settings, the media guidance application may generate secondary content at particular progression points. For example, the media guidance application may generate secondary content at a second progression point (e.g., prior to a first progression point during normal playback of a media assert) in order to emphasize or alert a user of an approaching desirable portion of the media asset at a first progression point. For example, with respect to the emotional response profile for the emotion of “joy,” peaks in the magnitude of the emotional response profile may indicate desirable (e.g., happy) portions of the media asset. For example, point 512 represents a progression point at which the magnitude of the emotional response profile peaks. In order to ensure that the user is paying attention, the media guidance application may generate a display of secondary content alerting the user that an upcoming scene of the media asset may be desirable.

In some embodiments, progression points may define particular portions of a media asset (e.g., a scene) that is undesirable. For example, emotional response profile 500 also includes points 514 and 516. Points 514 and 516 correspond to the emotional response profile for the emotion of “anger.” In some embodiments, the media guidance application may alter or replace content that may be undesirable to a user. For example, a portion of a media asset that causes a user to become angry may be removed. In FIG. 5A, the media guidance application may determine to remove/replace the portion of media asset from point 514 to point 516.

In some embodiments, the media guidance application may compare the emotional responses for a plurality of progression points to threshold emotional responses. For example, the media guidance application may compare the emotional responses from point 514 to point 516 to threshold emotional responses. In response to determining that the emotional responses from point 514 to point 516 correspond to threshold emotional responses, the media guidance application may generate a display of secondary content. For example, point 514 to point 516 may include the on-screen death of a favorite character. In response to determining that emotional response profile 500 indicates that this scene angers users, the media guidance application may remove this scene and replace it with a different scene (e.g., one in which the character does not die).

FIG. 5B is an illustrative diagram of an emotional response profile for a media asset being compared to an emotional response profile for a user. FIG. 5B shows emotional response profile 520, which indicates various representative emotional responses at different progression points of a media asset. FIG. 5B also includes emotional response profile 530, which indicates various emotional responses of a user as the user consumes the media asset.

For example, in some embodiments, the media guidance application may determine what, if any, secondary content should be generated for display based on the emotional responses of a user. For example, if a user appears to be exhibiting an emotional response greater that the representative emotional response for the media asset (e.g., the user is more scared than a typical user), the media guidance application may generate secondary content to compensate for the greater emotional response.

For example, in emotional response profile 520, point 522 corresponds to a “normal” representative emotional response. In contrast, in emotional response profile 530, point 532, which corresponds to the same progression point, corresponds to a “high” representative emotional response. Likewise, in emotional response profile 520, point 524 corresponds to a below “normal” representative emotional response. In contrast, in emotional response profile 530, point 534, which corresponds to the same progression point, corresponds to a “normal” representative emotional response. Based on this information, the media guidance application may generate a display of secondary content (e.g., a warning alerting the user to a portion of the media asset associated with a “high” representative emotional level) at or before point 526.

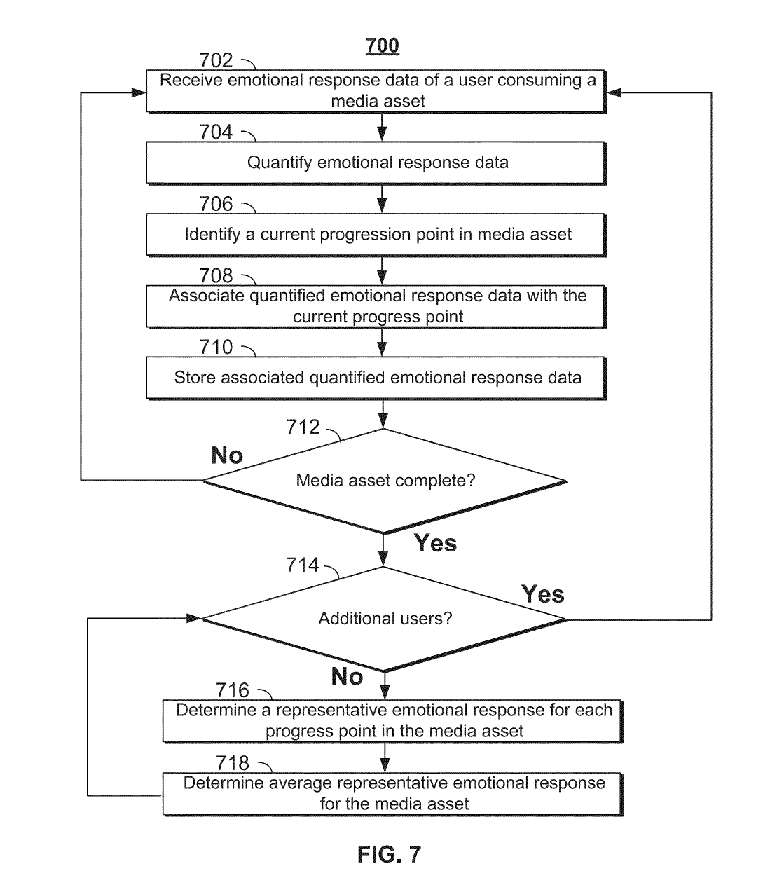

FIG. 6 is a flow-chart of illustrative steps involved in generating a display of secondary content for a media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to provide content as described in diagram 100 (FIG. 1) based on an emotional response profile (e.g., described in FIGS. 5A-B). In addition, one or more steps of process 600 may be incorporated into or combined with one or more steps of any other process or embodiment (e.g., process 700 (FIG. 7)).

At step 602, the media guidance application generates a display of a media asset to a user. For example, the media guidance application may (e.g., via control circuitry 304 (FIG. 3)) generate a display of a media asset (e.g., associated with program listing 108 (FIG. 1)). The media asset may be provided on a display (e.g., display 312 (FIG. 3)) associated with user equipment devices 402, 404, or 406 (FIG. 4)). In some embodiments, the media asset may be retrieved from local storage (e.g., storage 308 (FIG. 3)) or may be received via a communications network (e.g., communications network 414 (FIG. 4)) from a content provider (e.g., media content source 416 (FIG. 4)).

At step 604, the media guidance application identifies a first progression point of the media asset. For example, while the user is consuming the media asset, the media guidance application may determine the current progression point of the user. In some embodiments, the media guidance application (e.g., via control circuitry 304 (FIG. 4)) may continually perform step 604 as the user consumes the media asset. To identify the first progression point, the media guidance application may use numerous methods. For example, the media guidance application may (e.g., via control circuitry 304 (FIG. 3)) interpret metadata associated with each frame of a media asset that indicates the particular progression point. Additionally or alternatively, the media guidance application may (e.g., via control circuitry 304 (FIG. 3)) track the length of time that a media asset has been played back by a user. The media guidance application may also receive triggers (e.g., via I/O path 302 (FIG. 3)) transmitted from the media asset that indicate the current progression point.

At step 606, the media guidance application retrieves an emotional response profile associated with the media asset, in which the emotional response profile indicates representative emotional responses of other users associated with each progression point of the media asset. For example, the media guidance application may access (e.g., via control circuitry 304 (FIG. 3)) an emotional response profile (e.g., as discussed in relation to FIGS. 5A-B) describing the various emotional responses of other users. In some embodiments, the emotional response profile may be retrieved from local storage (e.g., storage 308 (FIG. 3)) or remote storage (e.g., media content source 416, media guidance data source 418, and/or any device accessible via communications network 414 (FIG. 4)). For example, in response to determining the media assets currently being presented to a user, the media guidance application may search a database associated with emotional response profiles for an emotional response profile associated with the media asset.

Alternatively or additionally, the media guidance application may receive (e.g., via I/O path 302 (FIG. 3)) the emotional response profile with the media asset (e.g., from media content source 416 (FIG. 4)). For example, in response to a user selecting a media asset, the provider of the media asset (e.g., media content source 416 (FIG. 4)) may transmit the media asset and the emotional response profile for the media asset to the user.

At step 608, the media guidance application may determine a first representative emotional response associated with the first progression point based on the emotional response profile. For example, as described above in relation to FIGS. 5A-B, the emotional response profile may indicate the emotional responses for a plurality of users at each progression point in the media asset. Upon retrieving the emotional response profile in step 606, the media guidance application (e.g., via control circuitry 304 (FIG. 3)) may cross-reference the identified first progression point with the emotional response profile. For example, the emotional response profile may be structured as a lookup table. The media guidance application may (e.g., via control circuitry 304 (FIG. 3)) input the identified first progression point into the table and the table may output a record of the emotional responses associated with that progression point.

In some embodiments, the representative emotional response associated with each progression point in the media asset is determined based on monitoring emotional responses of the other users while the other users are consuming the media assets and quantifying the emotional response of each of the other users at a progression point in the media asset. The media guidance application may monitor other users (e.g., via a monitoring module incorporated into and/or accessible by control circuitry 304 (FIG. 3)) or the media guidance application may receive the information (e.g., via I/O path 302 (FIG. 3)) from other media guidance applications associated with the other users or another source (e.g., a storage location accessible via communications network 414 (FIG. 4)). For example, the monitoring of other users and quantifying of the data may have been previously performed by one or more media guidance applications while a user consumes a media asset, been performed as part of industry research, or been performed using any other suitable technique, and the results of the monitoring (e.g., an emotional response profile) may be transmitted to and/or stored at one or more storage locations (e.g., storage 308 (FIG. 3), media content source 416 (FIG. 4)), media guidance data source 418 (FIG. 4)), and/or any location accessible via communications network 414 (FIG. 4)).

In some embodiments, the media guidance application may (e.g., via control circuitry 304 (FIG. 3)) then average the quantified emotional responses of each of the other users for the progression point in the media asset to determine the representative emotional response associated with the progression point in the media asset. For example, if a certain number of users experienced a high level of “sadness” at the thirty-minute mark of a media asset, the media guidance application may associate the thirty-minute mark with an emotional response of a high level of “sadness.”

At step 610, the media guidance application compares the first representative emotional response to a threshold emotional response. In some embodiments, as described in FIGS. 5A-B, the emotional response profile may include multiple representative emotional responses (e.g., corresponding to different emotions). The media guidance application may subsequently compare each of these emotional responses to respective threshold emotional responses. For example, the media guidance application may retrieve emotional responses associated with “sadness” and compare the emotional responses to a threshold emotional response associated with “sadness.” The media guidance application may then retrieve emotional responses associated with “anger” and compare the emotional responses to a threshold emotional response associated with “anger.”

In some embodiments, the threshold emotional response is based on the media guidance application quantifying the representative emotional responses associated with each progression point of the media asset and averaging the quantified representative emotional responses associated with each progression point of the media asset. For example, if a media asset has a series of four progression points associated with quantified representative emotional responses of levels four, six, eight, and two, respectively, the media guidance application may determine that average quantified representative emotional response associated with the media asset is five. It should be noted that the arithmetic mean is but one way to determine an average quantified representative emotional response, mathematical modes, medians, or other type of central or typical values may also be used.

The media guidance application may then select a deviation from the quantified representative emotional responses that corresponds to the threshold emotional response. For example, the media guidance application may determine that a deviation of a quantified representative emotional response for a particular progression point of the media asset of three or more units corresponds to the threshold emotional response. In such an example, if a media asset has a series of four progression points associated with quantified representative emotional responses of levels four, six, eight, and two, respectively, the media guidance application would determine that the third progression point corresponds to the threshold emotional response.

In another example, the media guidance application may set the threshold emotional response at a particular quantity. For example, the media guidance application may determine that any quantified representative emotional response for a particular progression point of the media asset of 6 or more units corresponds to the threshold emotional response. In such an example, if a media asset has a series of four progression points associated with quantified representative emotional responses of levels four, six, eight, and two, respectively, the media guidance application would determine that the second and third progression points (six and eight, respectively) correspond to the threshold emotional response.

At step 612, the media guidance application, in response to determining that the first representative emotional response corresponds to the threshold emotional response, generates a display of secondary content at a second progression point of the media asset. For example, in response to determining that a portion of a media asset (e.g., associated with the first progression point) corresponds to the threshold emotional response (e.g., indicating that the portion of the media asset associated with the first progression point is undesirable), the media guidance application may (e.g., via control circuitry 304 (FIG. 3)) provide secondary content in order to reduce undesirable emotional responses. In some embodiments, the secondary content may include an alert and/or other on-screen indication notifying the user of undesirable content (e.g., a warning indicating that an upcoming scene of a movie includes content meant to scare a user).

In another example, in response to determining that a portion of a media asset (e.g., associated with the first progression point) corresponds to the threshold emotional response (e.g., indicating that the portion of the media asset associated with the first progression point is desirable), the media guidance application may (e.g., via control circuitry 304 (FIG. 3)) provide secondary content in order to raise the awareness of the user to the desirability of the portions of the media asset. For example, the secondary content may include an alert, advertisement, recording reminder and/or other on-screen indication notifying the user that desirable content is being or will be displayed (e.g., a key plot twist in a movie, a touchdown during a football game, etc.).

Additionally or alternatively, the media guidance application may (e.g., via control circuitry 304 (FIG. 3)) use the secondary content to replace content. For example, the media guidance application may replace undesirable scenes or portions with more desirable scenes. For example, in response to determining that a user is not enjoying content or that other users typically did not enjoy the current content of a media asset (e.g., based on an emotional response profile), the media guidance application may provide alternative content. Additionally or alternatively, the media guidance application may (e.g., via control circuitry 304 (FIG. 3)) continuously update the media asset (e.g., as discussed in FIG. 5B above) based on the emotional responses of a user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

FIG. 7 is a flow-chart of illustrative steps involved in generating an emotional response profile. It should be noted that process 700 or any step thereof could be performed on, or provided by, any of the devices shown in FIGS. 3-4. For example, process 700 may be executed by control circuitry 304 (FIG. 3) as instructed by a media guidance application implemented on user equipment 402, 404, and/or 406 (FIG. 4) in order to provide content as described in diagram 100 (FIG. 1) based on an emotional response profile (e.g., described in FIGS. 5A-B). In addition, one or more steps of process 700 may be incorporated into or combined with one or more steps of any other process or embodiment (e.g., process 600 (FIG. 6)).

At step 702, the media guidance application receives emotional response data of a user consuming a media asset. In some embodiments, the media guidance application may (e.g., via a monitoring module incorporated into and/or accessible by control circuitry 304 (FIG. 3)) monitor emotional responses of a user consuming a media asset. Additionally or alternatively, the media guidance application may receive the information (e.g., via I/O path 302 (FIG. 3)) from other devices describing the emotional responses of the user consuming the media asset. In some embodiments, data associated with the emotional response of a user consuming a media asset may be collected by a third party (e.g., as part of industry research). In such embodiments, the results of the monitoring (e.g., an emotional response profile) may be transmitted to and/or stored at one or more storage locations (e.g., storage 308 (FIG. 3), media content source 416 (FIG. 4)), media guidance data source 418 (FIG. 4)), and/or any location accessible via communications network 414 (FIG. 4)).

At step 704, the media guidance application quantifies the emotional response data. To quantify the emotional response data, the media guidance application may apply any suitable strategy that distinguishes between various emotions and different levels of emotions. For example, the media guidance application may detect particular psychological or physiological conditions (e.g., as discussed above) associated with the user. The media guidance application may (e.g., via control circuitry 304 (FIG. 3)) input that data into a database (e.g., stored locally at storage 308 (FIG. 3) or remotely at any device accessible via communications network 414 (FIG. 4)) that indicates psychological or physiological conditions associated with an emotion. For example, in response to determining a particular heart rate, brain activity, perspiration level, visual indicia, etc. (e.g., via a monitoring module incorporated into and/or accessible by control circuitry 304 (FIG. 3)), the media guidance application may input the conditions into the database. The database may then output the quantified emotion(s) and/or level(s) of emotion associated with the various conditions.

At step 706, the media guidance application identifies a current progression point in the media asset. As discussed in relation to step 604 (FIG. 6), to identify the first progression point, the media guidance application may use numerous methods. For example, the media guidance application may (e.g., via control circuitry 304 (FIG. 3)) interpret metadata associated with each frame of a media asset that indicates the particular progression point. Additionally or alternatively, the media guidance application may (e.g., via control circuitry 304 (FIG. 3)) track the length of time that a media asset has been played back by a user. The media guidance application may also receive triggers (e.g., via I/O path 302 (FIG. 3)) transmitted from the media asset that indicate the current progression point.

At step 708, the media guidance application associates quantified emotional response data with the current progression point. For example, the media guidance application (e.g., via control circuitry 304 (FIG. 3)) matches the quantified emotional response data to the progression point in the media asset that the user was consuming when the emotional response data was received from the user.

At step 710, the media guidance application stores associated emotional response data. For example, by storing emotional response data associated with each progression point of the media asset, the media guidance application may (e.g., via control circuitry 304 (FIG. 3)) create an emotional response profile, based on the user, for the media asset. In some embodiments, the receipt and collection of emotional response data may occur in real-time. Alternatively, the emotional response data may be collected and associated with a current progress point at a later time or subject to a delay.

At step 712, the media guidance application determines if the media asset is complete. If the media asset is complete, the media guidance application proceeds to step 714. If the media asset is not complete, the media guidance application returns to step 702 to receive additional emotional response data. At step 714, the media guidance application determines if there are any other users consuming the media asset. For example, the media guidance application may collect associated emotional response data for a plurality of users, which may be aggregated to generate a representative emotional response for each progression point in the media asset. If there are additional users, the media guidance application returns to step 702. If there are no additional users, the media guidance application proceeds to step 716.

At step 716, the media guidance application determines a representative emotional response for each progression point in the media asset. To determine the representative emotional response for each progression point in the media asset, the media guidance application (e.g., via control circuitry 304 (FIG. 3)) averages the stored associated quantified emotional data for each user.

For example, if the media guidance application received emotional response data from four user for a particular progression point, the media guidance application may average the quantified emotional response data for each respective emotion. For example, if the quantified emotional response data associated with a first progression point for the emotion “fear” corresponded to four, five, three, and four, respectively, the media guidance application may determine that the representative emotional response associated with the first progression point for the emotion “fear” would be four. Likewise, if the quantified emotional response data associated with a first progression point for the emotion “happiness” corresponded to one, one, two, and four, respectively, the media guidance application may determine that the representative emotional response associated with the first progression point for the emotion “happiness” would be two. It should be noted that the arithmetic mean is but one way to determine an average quantified representative emotional response, mathematical modes, medians, or other type of central or typical values may also be used.

At step 718, the media guidance application determines the average representative emotional response for the media asset. For example, by determining the average quantity associated with each emotion, the media guidance application can establish a baseline for use in determining a deviation from the average representative emotional response. For example, as discussed above in relation to FIG. 6, if a media asset has a series of four progression points associated with quantified representative emotional responses of levels four, six, eight, and two, respectively, the media guidance application may (e.g., via control circuitry 304 (FIG. 3)) determine that average quantified representative emotional response associated with the media asset is five. It should be noted that the arithmetic mean is but one way to determine an average quantified representative emotional response, mathematical modes, medians, or other type of central or typical values may also be used.

Following step 718, the media guidance application returns to step 714 in order to determine if there are any additional users. For example, in some embodiments, the media guidance application may continually update the emotional response profile associated with a media asset as additional emotional response data is received from additional users consuming the media asset.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

What is claimed is:

1. A method for providing ancillary content in media assets, the method comprising:
generating a display of a media asset to a user;
identifying a first progression point of the media asset;
retrieving an emotional response profile associated with the media asset, wherein the emotional response profile indicates representative emotional responses of other users associated with each progression point of the media asset;
determining a first representative emotional response associated with the first progression point based on the emotional response profile;
comparing the first representative emotional response to a threshold emotional response; and
in response to determining that the first representative emotional response corresponds to the threshold emotional response, generating a display of secondary content at a second progression point of the media asset.

2. The method of claim 1, wherein the secondary content is not associated with a representative emotional response that corresponds to the threshold emotional response.

3. The method of claim 1, wherein the representative emotional responses associated with each progression point in the media asset are determined based on:
monitoring emotional responses of the other users while the other users are consuming the media asset;
quantifying the emotional response of each of the other users at a progression point in the media asset; and
averaging the quantified emotional responses of each of the other users for the progression point in the media asset to determine the representative emotional response associated with the progression point in the media asset.

4. The method of claim 3, wherein the threshold emotional response is based on:
quantifying the representative emotional responses associated with each progression point of the media asset;
averaging the quantified representative emotional responses associated with each progression point of the media asset; and
selecting a deviation from the quantified representative emotional responses that corresponds to the threshold emotional response.

5. The method of claim 4, wherein the deviation is based on deviations in other media assets consumed by the user.

6. The method of claim 1, wherein the threshold emotional response is selected by the user.

7. The method of claim 1, wherein the other users are selected based on a demographic, familial, or social network relationship with the user.

8. The method of claim 1, wherein the second progression point is before the first progression point, and wherein the secondary content is an alert indicating the first representative emotional response corresponds to the threshold emotional response.

9. The method of claim 1, wherein the second progression point is before the first progression point, and wherein the secondary content replaces content associated with the first progression point.

10. The method of claim 1, wherein the secondary content includes an advertisement.

11. A system for providing ancillary content in media assets, the system comprising control circuitry that:
generates a display of a media asset to a user;
identifies a first progression point of the media asset;
retrieves an emotional response profile associated with the media asset, wherein the emotional response profile indicates representative emotional responses of other users associated with each progression point of the media asset;
determines a first representative emotional response associated with the first progression point based on the emotional response profile;
compares the first representative emotional response to a threshold emotional response; and
in response to determining that the first representative emotional response corresponds to the threshold emotional response, generates a display of secondary content at a second progression point of the media asset.

12. The system of claim 11, wherein the secondary content is not associated with a representative emotional response that corresponds to the threshold emotional response.

13. The system of claim 11, wherein the control circuitry:
receives emotional responses of the other users while the other users are consuming the media asset;
quantifies the emotional response of each of the other users at a progression point in the media asset; and
averages the quantified emotional responses of each of the other users for the progression point in the media asset to determine the representative emotional response associated with the progression point in the media asset.

14. The system of claim 13, wherein the control circuitry:
quantifies the representative emotional responses associated with each progression point of the media asset;
averages the quantified representative emotional responses associated with each progression point of the media asset; and
selects a deviation from the quantified representative emotional responses that corresponds to the threshold emotional response.

15. The system of claim 14, wherein the deviation is based on deviations in other media assets consumed by the user.

16. The system of claim 11, wherein the threshold emotional response is selected by the user.

17. The system of claim 11, wherein the other users are selected based on a demographic, familial, or social network relationship with the user.

18. The system of claim 11, wherein the second progression point is before the first progression point, and wherein the secondary content is an alert indicating the first representative emotional response corresponds to the threshold emotional response.

19. The system of claim 11, wherein the second progression point is before the first progression point, and wherein the secondary content replaces content associated with the first progression point.

20. The system of claim 11, wherein the secondary content includes an advertisement.

21. A system for providing ancillary content in media assets, the system comprising:
means for generating a display of a media asset to a user;
means for identifying a first progression point of the media asset;
means for retrieving an emotional response profile associated with the media asset, wherein the emotional response profile indicates representative emotional responses of other users associated with each progression point of the media asset;
means for determining a first representative emotional response associated with the first progression point based on the emotional response profile;
means for comparing the first representative emotional response to a threshold emotional response; and
in response to determining that the first representative emotional response corresponds to the threshold emotional response, means for generating a display of secondary content at a second progression point of the media asset.

22. The system of claim 21, wherein the secondary content is not associated with a representative emotional response that corresponds to the threshold emotional response.

23. The system of claim 21, further comprising:
means for monitoring emotional responses of the other users while the other users are consuming the media asset;
means for quantifying the emotional response of each of the other users at a progression point in the media asset; and
means for averaging the quantified emotional responses of each of the other users for the progression point in the media asset to determine the representative emotional response associated with the progression point in the media asset.

24. The system of claim 23, further comprising:
means for quantifying the representative emotional responses associated with each progression point of the media asset;
means for averaging the quantified representative emotional responses associated with each progression point of the media asset; and
means for selecting a deviation from the quantified representative emotional responses that corresponds to the threshold emotional response.

25. The system of claim 24, wherein the deviation is based on deviations in other media assets consumed by the user.

26. The system of claim 21, wherein the threshold emotional response is selected by the user.

27. The system of claim 21, wherein the other users are selected based on a demographic, familial, or social network relationship with the user.

28. The system of claim 21, wherein the second progression point is before the first progression point, and wherein the secondary content is an alert indicating the first representative emotional response corresponds to the threshold emotional response.

29. The system of claim 21, wherein the second progression point is before the first progression point, and wherein the secondary content replaces content associated with the first progression point.

30. The system of claim 21, wherein the secondary content includes an advertisement.

31. A method for providing ancillary content in media assets, the method comprising:
generating a display of a media asset to a user on a user device;
identifying, using control circuitry, a first progression point of the media asset;
retrieving an emotional response profile associated with the media asset, wherein the emotional response profile indicates representative emotional responses of other users associated with each progression point of the media asset;
determining, using the control circuitry, a first representative emotional response associated with the first progression point based on the emotional response profile;
comparing, using the control circuitry, the first representative emotional response to a threshold emotional response; and
in response to determining that the first representative emotional response corresponds to the threshold emotional response, generating a display of secondary content at a second progression point of the media asset on the user device.

32. The method of claim 31, wherein the secondary content is not associated with a representative emotional response that corresponds to the threshold emotional response.

33. The method of claim 31 or 32, wherein the representative emotional responses associated with each progression point in the media asset is determined based on:
monitoring emotional responses of the other users while the other users are consuming the media asset;
quantifying the emotional response of each of the other users at a progression point in the media asset; and
averaging the quantified emotional responses of each of the other users for the progression point in the media asset to determine the representative emotional response associated with the progression point in the media asset.

34. The method of any one of claims 31-33, wherein the threshold emotional response is based on:
quantifying the representative emotional responses associated with each progression point of the media asset;
averaging the quantified representative emotional responses associated with each progression point of the media asset; and
selecting a deviation from the quantified representative emotional responses that corresponds to the threshold emotional response.

35. The method of claim 34, wherein the deviation is based on deviations in other media assets consumed by the user.

36. The method of any one of claims 31-35, wherein the threshold emotional response is selected by the user.

37. The method of any one of claims 31-36, wherein the other users are selected based on a demographic, familial, or social network relationship with the user.

38. The method of any one of claims 31-37, wherein the second progression point is before the first progression point, and wherein the secondary content is an alert indicating the first representative emotional response corresponds to the threshold emotional response.

39. The method of any one of claims 31-38, wherein the second progression point is before the first progression point, and wherein the secondary content replaces content associated with the first progression point.

40. The method of any one of claims 31-39, wherein the secondary content includes an advertisement.

41. Non-transitory computer readable storage media comprising machine readable instructions for:
generating a display of a media asset to a user;
identifying a first progression point of the media asset;
retrieving an emotional response profile associated with the media asset, wherein the emotional response profile indicates representative emotional responses of other users associated with each progression point of the media asset;
determining a first representative emotional response associated with the first progression point based on the emotional response profile;
comparing the first representative emotional response to a threshold emotional response; and
in response to determining that the first representative emotional response corresponds to the threshold emotional response, generating a display of secondary content at a second progression point of the media asset.

42. The non-transitory computer readable storage media of claim 41, wherein the secondary content is not associated with a representative emotional response that corresponds to the threshold emotional response.

43. The non-transitory computer readable storage media of claim 41, further comprising instructions for:
monitoring emotional responses of the other users while the other users are consuming the media asset;
quantifying the emotional response of each of the other users at a progression point in the media asset; and
averaging the quantified emotional responses of each of the other users for the progression point in the media asset to determine the representative emotional response associated with the progression point in the media asset.

44. The non-transitory computer readable storage media of claim 43, further comprising instructions for:
quantifying the representative emotional responses associated with each progression point of the media asset;
averaging the quantified representative emotional responses associated with each progression point of the media asset; and
selecting a deviation from the quantified representative emotional responses that corresponds to the threshold emotional response.

45. The non-transitory computer readable storage media of claim 44, wherein the deviation is based on deviations in other media assets consumed by the user.

46. The non-transitory computer readable storage media of claim 41, wherein the threshold emotional response is selected by the user.

47. The non-transitory computer readable storage media of claim 41, wherein the other users are selected based on a demographic, familial, or social network relationship with the user.

48. The non-transitory computer readable storage media of claim 41, wherein the second progression point is before the first progression point, and wherein the secondary content is an alert indicating the first representative emotional response corresponds to the threshold emotional response.

49. The non-transitory computer readable storage media of claim 41, wherein the second progression point is before the first progression point, and wherein the secondary content replaces content associated with the first progression point.

50. The non-transitory computer readable storage media of claim 41, wherein the secondary content includes an advertisement.
